(19) United States
(12) Patent Application Publication
(10) Pub. No.: US 2025/0188578 A1
(43) Pub. Date: Jun. 12, 2025

(54) MARAGING STEEL POWDER FOR ADDITIVE MANUFACTURING, MARAGING STEEL ADDITIVE MANUFACTURING PRODUCT, AND METHOD FOR PRODUCING SAME

(71) Applicant: Proterial, Ltd., Tokyo (JP)

(72) Inventors: Daiki Saito, Tokyo (JP); Norihide Fukuzawa, Tokyo (JP); Kazuya Saito, Tokyo (JP); Shiho Fukumoto, Tokyo (JP)

(73) Assignee: Proterial, Ltd., Tokyo (JP)

(21) Appl. No.: 18/845,421

(22) PCT Filed: Mar. 23, 2023
(86) PCT No.: PCT/JP2023/011469

§ 371 Date: Sep. 9, 2024

(30) Foreign Application Priority Data
Mar. 23, 2022 (JP) 2022-047635

(51) Int. Cl. C22C 38/10; B22F 10/28; B33Y 10/00; B33Y 70/00; B33Y 80/00; C22C 38/00; C22C 38/02; C22C 38/12; C22C 38/14

(52) U.S. Cl. CPC C22C 38/105; B22F 10/28; C22C 38/004; C22C 38/02; C22C 38/12; C22C 38/14; B33Y 10/00; B33Y 70/00; B33Y 80/00

(57) ABSTRACT

Provided is a maraging steel powder which allows an additive manufacturing product that has little deformation after manufacturing and exemplary thermal fatigue life characteristics to be obtained while reducing Co to the minimum. A maraging steel powder for additive manufacturing contains, in mass %, C: 0.02% or less, Si: 0.1 to 0.3%, Ni: 16 to 20%, Co: 0.1% or less, Mo: 2.5 to 3.5%, Ti: 1.5 to 2.5%, Al: 0.01% or less, and the remainder: Fe and inevitable impurities, and a maraging steel additive manufacturing product contains C: 0.02% or less, Si: 0.1 to 0.3%, Ni: 16 to 20%, Co: 0.1% or less, Mo: 2.5 to 3.5%, Ti: 1.5 to 2.5%, Al: 0.01% or less, and the remainder: Fe and inevitable impurities.

### TECHNICAL FIELD

The present invention relates to a maraging steel powder for additive manufacturing, a maraging steel additive manufacturing product, and a method for producing the same.

### DESCRIPTION OF RELATED ART

Recently, additive manufacturing has been attracting attention as a means for easily forming metal products (components) with complex shapes in near-net shapes. Additive manufacturing, also commonly known as 3D printing, is an additive manufacturing technology. Types of additive manufacturing methods include, for example, a powder spray method, in which a metal powder is irradiated with a heat source and layered while being melted, and a powder bed method, in which a metal powder spread on a stage is irradiated with a heat source and melted, and then being solidified, and the process is repeated to build up layers. According to additive manufacturing, metal products having complex shapes can be produced by largely eliminating the conventional machining processes, so that metal materials that are difficult to process can be used. Furthermore, since difficult-to-process metal materials are primarily high-strength metal materials, metal products having complex shapes and long service lives may be produced. One application for near-net machining of such complex three-dimensional shapes is die casting molds.

A typical example of high-strength metal materials is maraging steel. Maraging steel is, for example, an age-hardening type ultra-high strength steel in which age-hardening elements such as Co, Mo, Ti, and Al are added to steel containing about 18% of Ni in mass %. Furthermore, since maraging steel also has exemplary toughness, using maraging steel as a material for various tools and structural parts is effective in improving the service life of the products. In addition, an additive manufacturing product has been proposed that uses maraging steel as the metal material and is produced by the above-mentioned additive manufacturing method (Patent Literature 1).

A maraging steel powder has exemplary strength and toughness both as-manufactured and after aging treatment, making the maraging steel powder suitable for additive manufacturing of the above-mentioned die casting molds. As the maraging steel used for such mold applications, 300 ksi (kilopound-force per square inch) grade maraging steel is known, the general composition thereof is Fe-18% Ni-9% Co-5% Mo.

In the other hand, when using the powder bed method for additive manufacturing, there is a possibility that powders and dust may be released into the atmosphere during the process from powder to manufacturing, in particular, powders and dust containing Co have to be managed to prevent adverse effects on human health. Furthermore, since the addition of Co increases costs, there is a demand for a low Co maraging steel powder. For example, the applicant of the present application has proposed a powder for additive manufacturing, which is made of maraging steel with a composition of C: 0.1% or less, Ni: 14 to 22%, Co: 0 to 5%, Mo: 0.1 to 15.0%, Ti: 0.1 to 5.0%, Al: 3.0% or less, and the remainder being Fe and impurities. The powder described in Patent Literature 2 having the above-mentioned alloy composition may reduce Ti segregation, and may improve the toughness of maraging steel additive manufacturing products (Patent Literature 2).

Furthermore, a common problem that is known to occur in articles produced by additive manufacturing (additive manufacturing products) is the occurrence of distortion due to residual stress. As a method for suppressing the above-mentioned distortion in carbon steel or martensitic stainless steel that undergoes martensitic transformation, for example, a method has been proposed in which the martensitic transformation start temperature (Ms point) of the raw material powder is taken into consideration, and the temperature is adjusted between multiple layers of the additive manufacturing product using the temperature adjustment mechanism of the additive manufacturing device, thereby alleviating distortion in an additive manufacturing product (Patent Literature 3).

### RELATED ART

### Patent Literature

Patent Literature 1: International Publication No. WO 2011/149101
Patent Literature 2: Japanese Patent Application Laid-Open No. 2020-45567
Patent Literature 3: Japanese Patent No. 6295001

### SUMMARY

### Technical Problem

In the case of an additive manufacturing device that does not have a temperature adjustment mechanism as proposed in the above-mentioned Patent Literature 3, distortion caused by thermal contraction of the material during manufacturing could cause deformation or cracks in the additive manufacturing product. In particular, because low Co maraging steel with less than 1% of Co tends to have a larger deformation amount than general 300 ksi grade products, the deformation amount needs to be further suppressed.

On the other hand, one of the properties needed for die casting molds is that the molds are less susceptible to cracks caused by thermal fatigue (an improved thermal fatigue life). In order to obtain a mold with a long thermal fatigue life, a mold material is in demand that has high-temperature strength and that has good ductility and toughness at room temperature of the material (tempered material) obtained by heat-treating the additive manufacturing product after manufacturing. Therefore, the object of the present invention is to provide a maraging steel powder that can obtain an additive manufacturing product with little deformation after additive manufacturing and exemplary thermal fatigue life characteristics even if Co is reduced to the minimum, and to provide an additive manufacturing product using the same.

### Solution to the Problem

The present invention has been made in consideration of the above-mentioned problems.

That is, an embodiment of the present invention is a maraging steel powder for additive manufacturing, which consists of, in mass %, C: 0.02% or less, Si: 0.04 to 0.3%, Ni: 16 to 20%, Co: 0.1% or less, Mo: 2.5 to 3.5%, Ti: 1.5 to 2.5%, Al: 0.01% or less, and the remainder: Fe and inevitable impurities.

In addition, another embodiment of the present invention is a maraging steel additive manufacturing product, which consists of, in mass %, C: 0.02% or less, Si: 0.04 to 0.3%, Ni: 16 to 20%, Co: 0.1% or less, Mo: 2.5 to 3.5%, Ti: 1.5 to 2.5%, Al: 0.01% or less, and the remainder: Fe and inevitable impurities.

Moreover, another embodiment of the present invention is a method for producing a maraging steel additive manufacturing product, which includes a powder layer forming process in which the above-mentioned maraging steel powder for additive manufacturing is spread in a layer, a melting and solidification process in which the spread maraging steel powder for additive manufacturing is successively melted and solidified by a scanning heat source having a diameter larger than a D50 of the maraging steel powder for additive manufacturing to form a solidified layer, and the powder layer forming process and the melting and solidification process are repeated to obtain an additive manufacturing product.

### Effects

According to the present invention, even if Co is reduced to the minimum, an additive manufacturing product may be obtained that has little deformation after additive manufacturing and has exemplary thermal fatigue life characteristics.

### BRIEF DESCRIPTION OF THE DRAWINGS

FIG. 1 is a schematic diagram of a warpage measurement test piece used in distortion evaluation.

### DESCRIPTION OF EMBODIMENTS

The present invention has a component composition consisting of C: 0.02% or less, Si: 0.04 to 0.3%, Ni: 16 to 20%, Co: 0.1% or less, Mo: 2.5 to 3.5%, Ti: 1.5 to 2.5%, Al: 0.01% or less, and the remainder: Fe and inevitable impurities. First, the reasons for limiting the composition of the maraging steel for additive manufacturing defined in the present invention will be described. Unless otherwise specified, “%” refers to “mass %”.
C (carbon): 0.02% or less

In order to obtain a low-carbon martensite structure with high toughness, which is a characteristic of maraging steel, the C content has to be limited to 0.02% or less. If the C content exceeds 0.02%, the toughness of the as-manufactured material (the state after additive manufacturing but before heat treatment) decreases, and cracks may occur due to distortion caused by thermal contraction. The content is preferably 0.01% or less. On the other hand, C can also be used as a deoxidizer in the smelting process, and since it is difficult to eliminate addition thereof in terms of production, the lower limit can be set at, for example, 0.001%.
Si (silicon): 0.04 to 0.3%

Si is an element that improves strength, and the content thereof is set to 0.04% or more. On the other hand, since excessive addition of Si reduces the toughness of the tempered material, which is needed for improving the thermal fatigue life characteristics, the Si content is set to 0.3% at most. In order to further improve toughness, the upper limit of the Si content is preferably 0.2%, and more preferably 0.15%.
Ni (nickel): 16 to 20%

Ni is a fundamental element needed for the formation of maraging steel, which forms intermetallic compounds with Ti, Al, Mo, etc. and contributes to improving strength. For this reason, in the present invention, the Ni content is set to 16% or more. The lower limit of the Ni content is preferably 17%. On the other hand, if the Ni content is too high, the austenite structure is stabilized, making it difficult to form a martensite structure. For this reason, in the present invention, the Ni content is set to 20% or less. The upper limit of the Ni content is preferably 19%.
Co (cobalt): 0.1% or less

In the present invention, the Co content is reduced in consideration of the ease of management regarding the effects on human health and the high cost of Co itself. Furthermore, in the present invention, it has been found that by extremely reducing the content of Co, which has the effect of lowering the solid solubility limit of Mo, to 0.1% or less, an effect of improving the toughness of the tempered material is exerted. This is believed to be because the toughness needed for thermal fatigue life characteristics is improved by reducing the excessive precipitation of Mo-based intermetallic compounds. The upper limit is preferably 0.05%, and more preferably 0.01%. It is ideal to add no Co (0%), but since this is difficult in production, the lower limit can be set at, for example, 0.0005%.
Mo (molybdenum): 2.5 to 3.5%

Mo forms an intermetallic compound, Ni₃Mo, during aging treatment, and precipitation strengthens the metal structure. Alternatively, Mo is an element that has the effect of improving strength and thermal fatigue life by solid solution strengthening. Furthermore, the addition of Mo lowers the Ms point in compositions such as low Co maraging steel. In the case of an additive manufacturing device that does not have a temperature adjustment mechanism, the temperature during manufacturing may be close to room temperature depending on the manufacturing conditions. However, by lowering the Ms point and bringing the Ms point closer to room temperature, the effect of mitigating thermal contraction due to martensitic transformation expansion can be utilized, thereby reducing deformation due to thermal contraction. For this reason, in the present invention, the Mo content is preferably 2.5% or more.

On the other hand, if the Mo content is too high, coarse intermetallic compounds are formed in excess with Fe, decreasing the toughness of the tempered material, which is needed for thermal fatigue life characteristics. Moreover, the addition of excessive Mo lowers the Ms point more than needed, making it difficult to form a martensite structure. For this reason, in the present invention, the Mo content is preferably 3.5% or less.
Ti (titanium): 1.5 to 2.5%

Ti is an element that forms a strengthening phase, Ni₃Ti, in the structure after aging treatment and imparts high-temperature strength needed for thermal fatigue life characteristics. For this reason, in the present invention, the Ti content is set to 1.5% or more. For the same reasons as above, the Ti content is preferably 1.7% or more, and more preferably 1.9% or more.

On the other hand, if the Ti content is too high, significant Ti segregation occurs in the structure during solidification. Furthermore, the significant Ti segregation may remain in the structure even after aging treatment, decreasing the toughness of the tempered material that is needed for thermal fatigue life characteristics. For this reason, in the present invention, the Ti content is set to 2.5% or less. For the same reasons as above, the Ti content is preferably 2.3% or less, and more preferably 2.1% or less.
Al (aluminum): 0.01% or less

Al forms an intermetallic compound with Ni and has the effect of precipitation strengthening the metal structure. However, if the content is too high, nonmetallic inclusions increase in the metal structure, which may reduce toughness. Therefore, it is preferable that the content be 0.01% or less. Furthermore, since the strength of the intermetallic compounds can be imparted by Mo or Ti, the number of elements to be handled can be reduced and the production management process can be omitted. The basic component composition of the present invention selectively contains the above-mentioned element types, with the remainder being Fe and inevitable impurities.

Moreover, the maraging steel powder for additive manufacturing of the present invention preferably contains, in mass %, 0.030% or less of N (nitrogen). N (nitrogen) is an element that is inevitably incorporated into a metal powder from the raw materials and the atmosphere in the melting and pulverization processes during the production process of the metal powder. If the N (nitrogen) content is too high, N bonds with Ti, Mo, etc. in the additive manufacturing product and forms a large amount of nitrides. The nitrides may act as starting points for fracture and reduce the toughness of the tempered material. For this reason, in the present invention, the N (nitrogen) content is preferably 0.030% or less, more preferably 0.020% or less, and further preferably 0.005% or less.

However, N is an element that is inevitably mixed in during general production processes for powders for additive manufacturing, such as a gas atomization method. The maraging steel powder for additive manufacturing according to an embodiment of the present invention suppresses an internal defect in an additive manufacturing product, and from the viewpoint of ensuring sufficient toughness, the N (nitrogen) content of 0.001% or more is permissible.

The maraging steel powder for additive manufacturing of the present invention preferably has an O (oxygen) content of 0.040% or less. O (oxygen) is an element that is inevitably incorporated into a metal powder from the raw materials and the atmosphere in the melting and pulverization processes during the production process of the metal powder. O (oxygen) bonds with Ti and the like and forms oxides inside and on the surface of the metal powder. The oxides may act as starting points for fracture and reduce toughness. For this reason, in the present invention, the O (oxygen) content is preferably 0.040% or less, more preferably 0.030% or less, and further preferably 0.020% or less.

The maraging steel powder for additive manufacturing of the present invention suppresses an internal defect in an additive manufacturing product, and from the viewpoint of ensuring sufficient toughness, the O (oxygen) content of 0.005% or more, or 0.010% or more is permissible.

The maraging steel powder for additive manufacturing of the present invention can be produced by, for example, a gas atomization method, a water atomization method, a disk atomization method, a plasma atomization method, a rotating electrode method, or the like. Among the methods, in the gas atomization method, melting materials prepared to have the desired composition are heated to above melting points thereof by high-frequency induction heating, and then melted, the molten metal that flows out through fine holes is finely crushed by injecting an inert gas such as argon gas or nitrogen gas into the molten metal, and the molten metal is then rapidly cooled and solidified to obtain a powder. The gas atomization method may use scrap metals and raw metal materials as melting materials, compared to plasma atomization and rotating electrode methods, which need the preparation of raw materials with the desired component composition and shape in advance, the method allows production at a lower cost, and is suitable as a method for obtaining the metal powder for additive manufacturing of the present invention.

The maraging steel powder for additive manufacturing of the present invention preferably has a 50% particle size (hereinafter referred to as “D50”) of a cumulative particle size distribution on a volume basis of 10 to 250 μm. By setting the D50 of the metal powder for additive manufacturing of the present invention to 250 m or less, the powder can be easily melted and the formation of an internal defect in the additive manufacturing product can be suppressed.

In addition, by setting the D50 of the metal powder for additive manufacturing of the present invention to 10 μm or more, the metal powder is less susceptible to the effects of moisture and the like in the atmosphere during handling and additive manufacturing, and good fluidity can be ensured.

The cumulative particle size distribution of the powder for manufacturing of the present invention is expressed as a cumulative volumetric particle size distribution, and the D50 can be expressed as a value measured by the laser diffraction scattering method defined in JIS Z 8825.

In accordance with the above-mentioned method, the D50 of the metal powder of the maraging steel powder for additive manufacturing of the present invention may be adjusted by sieving classification using a mesh or air flow classification. For example, the metal powder for additive manufacturing used in the powder bed method is melted by a laser beam, which acts as a heat source, but a coarse metal powder that is difficult to melt has to be removed in order to minimize the area affected by heat. Also, a fine metal powder that has high adhesiveness has to be removed in order to obtain optimal fluidity to ensure the laying down of the metal powder. For this reason, when the maraging steel powder for additive manufacturing of the present invention is applied to the powder bed method, it is preferable to adjust the D50 to the range of 10 to 53 μm. The upper limit of D50 is preferably 40 m, and the lower limit of D50 is preferably 20 μm.

The above-mentioned maraging steel powder for additive manufacturing of the present invention is additively manufactured using a production method described below, thereby obtaining a maraging steel additive manufacturing product consisting of, in mass %, C: 0.02% or less, Si: 0.04 to 0.3%, Ni: 16 to 20%, Co: 0.1% or less, Mo: 2.5 to 3.5%, Ti: 1.5 to 2.5%, Al: 0.01% or less, and the remainder: Fe and inevitable impurities. The additive manufacturing product has a small amount of deformation due to thermal contraction and has exemplary thermal fatigue life characteristics. The exemplary suitable application of the additive manufacturing product is a die-casting mold, but may also be applicable to other molds that need internal cooling mechanisms, such as plastic molds. The additive manufacturing product may also be applicable to repairing molds using powder spray additive manufacturing. Furthermore, the application is not limited to molds, but may also be applicable to various other tools, gears, and other components that use maraging steel.

Next, a production method of the present invention that can obtain the additive manufacturing product of the present invention by using the maraging steel powder of the present invention will be described. The production process described below may be applied to, for example, a powder bed method.

In the production method according to the present invention, a process in which the prepared maraging steel powder for additive manufacturing (hereinafter also referred to as “metal powder”) of the present invention is spread in a layer and a process in which the spread metal powder is successively melted and solidified by a scanning heat source having a diameter larger than the D50 of the metal powder to form a solidified layer are carried out. The process in which the metal powder is spread in a layer and the process in which the solidified layer is formed are repeated to form multiple layers of the solidified layer, and the additive manufacturing object of the present invention can be produced. The scanning heat source may be, for example, a laser or an electron beam. It is preferable to make the diameter of the scanning heat source larger than the D50 of the metal powder, so the aggregate of the metal powder may be melted uniformly.

In the production method according to the present invention, when the above-mentioned metal powder is irradiated with a laser while being scanned, the laser output can be set to 50 to 350 W, the scanning speed can be set to 200 to 2000 mm/sec, and the scanning pitch can be set to 0.02 to 0.20 mm. If the layer thickness per laser scan is too large, the heat is not easily transferred to the entire spread metal powder during laser irradiation, and the metal powder does not melt sufficiently, which promotes the formation of an internal defect. On the other hand, if the layer thickness per scan is too small, the number of layers needed to achieve a desired size of the additive manufacturing product increases, and the time needed for the additive manufacturing process increases. For this reason, the layer thickness per scan is preferably 10 to 200 μm. A more preferable lower limit of the layer thickness is 20 m, and a more preferable upper limit of the layer thickness is 100 m.

In the production method according to the present invention, in order to impart the mechanical properties needed for use as a metal product (part), it is preferable to subject the as-additively manufactured component (i.e., the component has not been subjected to heat treatment after additive manufacturing) to aging treatment. The aging treatment of the additive manufacturing product of the present invention causes various intermetallic compounds to precipitate in the structure, for example, it is useful in that the hardness can be adjusted to 40 to 55 HRC to obtain superior high strength and high toughness. The aging treatment temperature is preferably 400° C. or higher, more preferably 450° C. or higher, further preferably 500° C. or higher, and even further preferably 550° C. or higher. By increasing the aging treatment temperature, the effect of improving the strength due to the precipitation of Ni₃Ti is able to be obtained. However, if the aging treatment temperature is too high, the intermetallic compounds become coarse, and sufficient strength commensurate with the amount of precipitation of the intermetallic compounds is unable to be obtained. Therefore, the aging treatment temperature is preferably 700° C. or lower, more preferably 650° C. or lower, further preferably 640° C. or lower, and even further preferably 630° C. or lower. The aging treatment temperature may also be set to 600° C. or lower.

The aging treatment time (maintenance time at the aging treatment temperature) is preferably 60 minutes or more, more preferably 100 minutes or more, and further preferably 150 minutes or more. By increasing the aging treatment time, the amounts of various intermetallic compounds increase. However, if the aging treatment time is too long, the intermetallic compounds become coarse and the strength decreases. Therefore, the aging treatment time is preferably 600 minutes or less, more preferably 400 minutes or less, and further preferably 200 minutes or less. The aging treatment may be carried out multiple times to adjust (temper) the hardness to a specific value while measuring the hardness at regular intervals. In addition, in the heat treatment of an additive manufacturing product, since the melting and rapid cooling during manufacturing sometimes serve as a quenching process, unlike general melting materials, the solution treatment is sometimes omitted and the as-manufactured material is directly subjected to aging treatment. The production method of the present invention has been described above, but the maraging steel powder for additive manufacturing of the present invention is not limited thereto, and may also be, for example, applied to a direct metal deposition method in which a powder is sprayed directly onto a heat source and melted onto a substrate.

In the production method according to the present invention, solution treatment may be carried out prior to the above-mentioned aging treatment in order to improve mechanical properties and eliminate segregation. The solution treatment temperature is preferably 800° C. or higher, more preferably 850° C. or higher, further preferably 900° C. or higher, and even further preferably 950° C. or higher. By increasing the solution treatment temperature, the effect of eliminating segregation formed during additive manufacturing is improved. However, if the solution treatment temperature is too high, the prior austenite grains become coarse, resulting in a decrease in the strength and toughness of the additive manufacturing product. Therefore, the solution treatment temperature is preferably 1200° C. or lower, more preferably 1100° C. or lower, and further preferably 1050° C. or lower.

The solution treatment time (maintenance time at the solution treatment temperature) is preferably 10 minutes or more, more preferably 30 minutes or more, and further preferably 45 minutes or more. By increasing the solution treatment time, the effect of eliminating segregation formed during additive manufacturing is improved. However, if the solution treatment time is too long, the prior austenite grain size becomes coarse. Therefore, the solution treatment time is preferably 120 minutes or less, more preferably 100 minutes or less, and further preferably 80 minutes or less. Here, in an additive manufacturing product, there is also a product that is used as a composite by additively manufacturing another material on a base material. When an additive manufacturing product is used in a mold, maraging steel may be additively manufactured onto general tool steel to form a composite. Tool steel is usually hardened before use. For example, the hardening temperature for SKD61, general hot work tool steel, is around 1000° C. When an additive manufacturing product is used as a composite, such a composite can serve both the hardening of the tool steel and the solution treatment of the maraging steel.

### EXAMPLE

### Example 1

After preparing each of raw metal materials so as to have the component composition shown in Table 1, the material was charged into a high-frequency induction melting furnace and melted, and the molten metal was pulverized with argon gas to obtain a gas atomized powder. The particle size of the obtained atomized powder was adjusted by performing sieving classification using a mesh and air flow classification, and powders for additive manufacturing of the present invention and comparative examples having a D50 of 35 μm were obtained. For each of the metal powders for additive manufacturing obtained above, additive manufacturing products were fabricated under the manufacturing conditions shown in Table 2 using Mlab Cusing 200R manufactured by GE Additive. Table 3 shows the component composition values of the obtained additive manufacturing products.

TABLE 1
(mass %)

| Sample No. | C | Si | Ni | Mo | Co | Al | Ti | N | O | Fe^{※} | Remark |
|---|---|---|---|---|---|---|---|---|---|---|---|
| 1 | 0.005 | 0.12 | 18.2 | 2.7 | 0.005 | 0.001 | 1.99 | <0.001 | 0.0181 | Bal. | Examples of |
| 2 | 0.005 | 0.12 | 18.2 | 3.3 | 0.002 | 0.001 | 1.96 | <0.001 | 0.0195 | Bal. | present |
| | | | | | | | | | | | invention |
| 3 | 0.009 | 0.29 | 17.9 | 2.0 | 0.51 | 0.14 | 1.99 | <0.001 | 0.0272 | Bal. | Comparative |
| | | | | | | | | | | | example |

^{※}Contain inevitable impurities

TABLE 2

| | | | | | Laser diameter |
|---|---|---|---|---|---|
| | Laser | Scanning | Layer | Scanning | (diameter of scanning |
| | output | speed | thickness | pitch | heat source) |
| | [W] | [mm/s] | [μm] | [mm] | [μm] |
| Manufacturing | 180 | 850 | 30 | 0.08 | 75 |
| conditions | | | | | |

TABLE 3
(mass %)

| Sample No. | C | Si | Ni | Mo | Co | Al | Ti | Fe^{※} | Remark |
|---|---|---|---|---|---|---|---|---|---|
| 1 | 0.005 | 0.12 | 18.1 | 2.8 | <0.01 | 0.001 | 2.01 | Bal. | Examples of |
| 2 | 0.004 | 0.12 | 18.0 | 3.4 | <0.01 | 0.002 | 1.98 | Bal. | present |
| | | | | | | | | | invention |
| 3 | 0.007 | 0.30 | 18.1 | 2.0 | 0.49 | 0.14 | 2.03 | Bal. | Comparative |
| | | | | | | | | | example |

^{※}Contain inevitable impurities

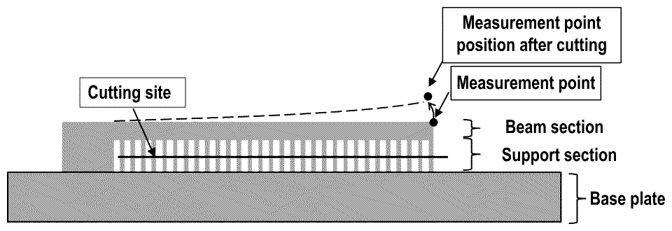

First, the deformation amount of the additive manufacturing product was measured. First, as additive manufacturing products of the present invention and the comparative example, a cantilever-shaped test piece shown in FIG. 1 was fabricated on a base plate. Next, the cutting site of the support section shown in FIG. 1 was cut by wire electric discharge machining, and the accumulated distortion caused the beam section to warp. This confirmed that the greater the warpage, the more distortion accumulated in the additive manufacturing product.

Next, the height of the measurement point at the end section of the beam section relative to the base plate was measured before and after cutting the support section. As shown in Table 4, the deformation amounts of both the additive manufacturing products made of the Co-free maraging steel of the examples of the present invention were smaller than the deformation amount of the low Co maraging steel of the comparative example, and it was confirmed that the additive manufacturing product of the present invention can suppress deformation during manufacturing even if the Co content is reduced to the minimum.

TABLE 4

| | Amount of change in height | |
|---|---|---|
| | of the measurement point | |
| | before and after cutting | |
| | (deformation amount) | |
| Sample No. | [mm] | Remark |
| 1 | 1.03 | Examples of |
| | | present |
| 2 | 0.91 | invention |
| 3 | 1.37 | Comparative |
| | | example |

### Example 2

Next, to confirm the mechanical properties of the additive manufacturing product, the same additive manufacturing products as those fabricated in Example 1 were subjected to heat treatment under the conditions shown in Table 5, and were tempered to have hardness of 46±1 HRC and 52±1 HRC. Here, Samples Nos. 4 to 7 are obtained by subjecting Sample No. 1 of Example 1 to heat treatment, and Samples Nos. 8 to 11 are obtained by subjecting Sample No. 2 of Example 1 to heat treatment, and Samples No. 12 to 15 are Sample No. 3 that has been subjected to heat treatment. For the samples that were solution-treated, the temperature and time were determined assuming heat treatment that combined quenching and solution treatment of the tool steel when maraging steel was additively manufactured on top of general tool steel to form a composite. The hardness was measured by a Rockwell hardness test according to JIS Z 2245. A tensile test piece was taken from the tempered additive manufacturing product in the direction parallel to the layering direction, and a high-temperature tensile test at 550° C. and a room-temperature tensile test at 22° C. in accordance with JIS Z 2241, and a 2 mm U-notch Charpy impact test in accordance with JIS Z 2242 were carried out.

TABLE 5

| Sam- | Solution | Aging treatment (3 hours) | | | Actual | |
|---|---|---|---|---|---|---|
| ple | treatment | 1^{st} | 2^{nd} | 3^{rd} | hardness | |
| No. | (1 hour) | time | time | time | [HRC] | Remark |
| 4 | None | 490° C. | — | — | 52.1 | Examples of |
| 5 | None | 580° C. | 570° C. | — | 46.4 | present |
| 6 | 1020° C. | 530° C. | — | — | 52.4 | invention |
| 7 | 1020° C. | 590° C. | 590° C. | — | 46.4 | |
| 8 | None | 500° C. | — | — | 51.8 | |
| 9 | None | 590° C. | — | — | 46.4 | |
| 10 | 1020° C. | 530° C. | 530° C. | — | 52.6 | |
| 11 | 1020° C. | 600° C. | 590° C. | — | 45.9 | |
| 12 | None | 510° C. | — | — | 51.8 | Comparative |
| 13 | None | 595° C. | — | — | 45.6 | examples |
| 14 | 1020° C. | 540° C. | — | — | 52.2 | |
| 15 | 1020° C. | 600° C. | 565° C. | 590° C. | 46.4 | |

Table 6 shows the thermal fatigue life characteristics of the 550° C.-0.2% yield strength (high temperature yield strength) and room temperature reduction and 2 mm U-notch Charpy impact value indicating toughness for the non-solution-treated-aging-treated 52HRC tempered material. Table 7 shows the thermal fatigue life characteristics of the 550° C.-0.2% yield strength (high temperature yield strength) and room temperature reduction and 2 mm U-notch Charpy impact value indicating toughness for the non-solution-treated-aging-treated 46HRC tempered material. When compared with samples tempered to the same hardness, the examples of the present invention exhibited higher high temperature yield strength and Charpy impact value than the comparative examples. From the above results, it was confirmed that the present invention allows an additive manufacturing product with thermal fatigue life characteristics exceeding those of conventional low Co maraging steel to be obtained under a heat treatment condition that omits solution treatment.

TABLE 6

| | | Room | | |
|---|---|---|---|---|
| | 550° C.-0.2% yield | temperature | Charpy | |
| Sample | strength | reduction | impact value | |
| No. | [MPa] | [%] | [J/cm²] | Remark |
| 4 | 681 | 42 | 45 | Examples of |
| | | | | present |
| 8 | 698 | 42 | 43 | invention |
| 12 | 616 | 42 | 37 | Comparative |
| | | | | example |

TABLE 7

| | | Room | | |
|---|---|---|---|---|
| | 550° C.-0.2% yield | temperature | Charpy | |
| Sample | strength | reduction | impact value | |
| No. | [MPa] | [%] | [J/cm²] | Remark |
| 5 | 555 | 47 | 71 | Examples of |
| | | | | present |
| 9 | 551 | 49 | 76 | invention |
| 13 | 507 | 48 | 52 | Comparative |
| | | | | example |

Table 8 shows the thermal fatigue life characteristics of the 550° C.-0.2% yield strength (high temperature yield strength) and room temperature reduction and 2 mm U-notch Charpy impact value indicating toughness for the solution-treated 1020° C.-aging-treated 52HRC tempered material. Table 9 shows the thermal fatigue life characteristics of the 550° C.-0.2% yield strength (high temperature yield strength) and room temperature reduction and 2 mm U-notch Charpy impact value indicating toughness for the solution-treated 1020° C.-aging-treated 46HRC tempered material. When compared with samples tempered to the same hardness, the examples of the present invention exhibited higher high temperature yield strength and Charpy impact value than the comparative examples. It was confirmed that even under a heat treatment condition that combines quenching and solution treatment of tool steel when maraging steel is additively manufactured on top of general tool steel to form a composite, the present invention allows an additive manufacturing product with thermal fatigue life characteristics exceeding those of conventional Co-free maraging steel to be obtained.

TABLE 8

| | | Room | | |
|---|---|---|---|---|
| | 550° C.-0.2% yield | temperature | Charpy | |
| Sample | strength | reduction | impact value | |
| No. | [MPa] | [%] | [J/cm²] | Remark |
| 6 | 816 | 41 | 33 | Examples of |
| | | | | present |
| 10 | 843 | 36 | 35 | invention |
| 14 | 769 | 32 | 31 | Comparative |
| | | | | example |

TABLE 9

| | | Room | | |
|---|---|---|---|---|
| | 550° C.-0.2% yield | temperature | Charpy | |
| Sample | strength | reduction | impact value | |
| No. | [MPa] | [%] | [J/cm²] | Remark |
| 7 | 623 | 44 | 53 | Examples of |
| | | | | present |
| 11 | 610 | 46 | 50 | invention |
| 15 | 590 | 42 | 41 | Comparative |
| | | | | example |

What is claimed is:

1. A maraging steel powder for additive manufacturing, comprising: in mass %, C:
0.02% or less, Si: 0.04 to 0.3%, Ni: 16 to 20%, Co: 0.1% or less, Mo: 2.5 to 3.5%, Ti: 1.5 to 2.5%, Al: 0.01% or less, and the remainder: Fe and inevitable impurities.

2. A maraging steel additive manufacturing product, comprising: in mass %, C: 0.02% or less, Si: 0.04 to 0.3%, Ni: 16 to 20%, Co: 0.1% or less, Mo: 2.5 to 3.5%, Ti: 1.5 to 2.5%, Al: 0.01% or less, and the remainder: Fe and inevitable impurities.

3. A method for producing a maraging steel additive manufacturing product, comprising:
a powder layer forming process of spreading the maraging steel powder for additive manufacturing according to claim 1 in a layer; and
a melting and solidification process of forming a solidified layer by successively melting and solidifying the spread maraging steel powder for additive manufacturing by a scanning heat source having a diameter larger than a D50 of the maraging steel powder for additive manufacturing, and
repeating the powder layer forming process and the melting and solidification process to obtain an additive manufacturing product.
